(19) United States
(12) Patent Application Publication
(10) Pub. No.: US 2021/0010240 A1
(43) Pub. Date: Jan. 14, 2021

(54) SYSTEM AND METHOD FOR CONTROLLING THE OPERATION OF A WORK VEHICLE BASED ON A DESIRED TURNING RADIUS

(71) Applicant: CNH Industrial America LLC, New Holland, PA (US)

(72) Inventor: Joseph R. Shoemaker, West Burlington, IA (US)

(73) Assignee: CNH INDUSTRIAL AMERICA LLC

(21) Appl. No.: 16/505,813

(22) Filed: Jul. 9, 2019

(51) Int. Cl. E02F 9/22; B62D 11/00; B62D 15/02; B60K 35/00; B62D 11/04; E02F 9/20; B62D 55/06; E02F 9/02; E02F 9/26

(52) U.S. Cl. CPC E02F 9/225; E02F 9/2292; B62D 15/024; B60K 35/00; B62D 11/04; E02F 9/2004; B62D 55/06; E02F 9/02; E02F 9/2087; E02F 9/26; B60K 2370/115; B60K 2370/152; B60K 2370/168; B60K 2370/175; B62D 11/003

(57) ABSTRACT

In one aspect, a system for controlling the operation of a work vehicle may include a controller may be configured to provide for display on a user interface the turning radius of the work vehicle. The controller may also be configured to receive an input associated with an operator selection of the displayed turning radius as a desired turning radius of the work vehicle. Moreover, the controller may be configured to determine a first and second rotational speeds for first and second traction devices of the work vehicle based on the desired turning radius. In addition, the controller may be configured to control the operation of first and second motors to rotationally drive the first and second traction devices at the first and second rotational speeds, respectively, such that the work vehicle is moved along a travel path having the desired turning radius.

### FIELD OF THE INVENTION

The present disclosure generally relates to work vehicles and, more particularly, to systems and methods for controlling the operation of a work vehicle such that the work vehicle is moved along a travel path having a desired turning radius, thereby allowing the work vehicle executes a constant radius turn.

### BACKGROUND OF THE INVENTION

Work vehicles typically include an operator control device, such as a joystick, a steering wheel, and/or the like, for controlling the direction of travel of the vehicle. In this regard, the operator of the work vehicle may adjust the direction of travel of the work vehicle by providing a steering input to the operator control device. Thereafter, one or components (e.g., a hydraulic motor(s), a steering actuator(s), and/or the like) of the work vehicle are controlled such that the direction of travel of the vehicle is changed based on the steering input.

In certain instances, it may be necessary for the work vehicle to move along a travel path having a generally constant turning radius. However, it may be difficult for the operator of the work vehicle to provide a constant steering input such that the vehicle executes a constant radius turn. Moreover, it is particularly difficult for the operator to provide such a steering input when the surface across which the work vehicle is traveling is rough and/or the duration of the constant radius turn is long.

Accordingly, an improved system and method for controlling the operation of a work vehicle such that the vehicle is able to execute turns having a generally constant radius would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to a system for controlling the operation of a work vehicle. The system may include first and second traction devices, with one of the first traction device or the second traction device corresponding to an inner traction device of the work vehicle and the other of the first traction device or the second traction device corresponding to an outer traction device of the work vehicle when the work vehicle is being turned. The system may also include a first motor configured to rotationally drive the first traction device and a second motor configured to rotationally drive the second traction device. Furthermore, the system may include a user interface configured to display a turning radius of the work vehicle. Additionally, the system may include a controller communicatively coupled to the user interface. As such, the controller may be configured to provide for display on the user interface the turning radius of the work vehicle and receive an input associated with an operator selection of the displayed turning radius as a desired turning radius. Moreover, the controller may be configured to determine a first rotational speed for the first traction device and a second rotational speed for the second traction device based on the desired turning radius, with the first rotational speed differing from the second rotational speed by a rotational speed differential associated with the desired turning radius. In addition, the controller may be configured to control the operation of the first and second motors to rotationally drive the first and second traction devices at the first and second rotational speeds, respectively, such that the work vehicle is moved along a travel path having the desired turning radius.

In another aspect, the present subject matter is directed to a method for controlling the operation of a work vehicle. The work vehicle may include first and second traction devices, a first motor configured to rotationally drive the first traction device, and a second motor configured to rotationally drive the second traction device. The method may include providing, with one or more computing devices, a turning radius of the work vehicle for display on a user interface of the work vehicle. The user interface may, in turn, be configured to display the turning radius of the work vehicle. Moreover, the method may include receiving, with the one or more computing devices, an input associated with an operator selection of the displayed turning radius as a desired turning radius. Furthermore, the method may include determining, with the one or more computing devices, a first rotational speed for the first traction device and a second rotational speed for the second traction device based on the desired turning radius, with the first rotational speed differing from the second rotational speed by a rotational speed differential associated with the desired turning radius. Additionally, the method may include controlling, with the one or more computing devices, the operation of the first and second motors to rotationally drive the first and second traction devices at the first and second rotational speeds, respectively, such that the work vehicle is moved along a travel path having the desired turning radius.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of one embodiment of a work vehicle in accordance with aspects of the present subject matter;

FIG. 2 illustrates a schematic view of various components of the work vehicle shown in FIG. 1, particularly illustrating a hydrostatic transmission of the work vehicle in accordance with aspects of the present subject matter;

FIG. 3 illustrates a schematic view of one embodiment of a system for controlling the operation of a work vehicle in accordance with aspects of the present subject matter;

FIG. 4 illustrates an example view of a user interface of a work vehicle for displaying a turning radius to an operator of the vehicle and receiving an operator selection of the displayed turning radius as a desired turning radius of the vehicle in accordance with aspects of the present subject matter;

FIG. 5 illustrates another example view of a user interface of a work vehicle for displaying a turning radius to an operator of the vehicle and receiving an operator selection of the displayed turning radius as a desired turning radius of the vehicle in accordance with aspects of the present subject matter; and

FIG. 6 illustrates a flow diagram of one embodiment of a method for controlling the operation of a work vehicle in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems and methods for controlling the operation of a work vehicle. Specifically, in several embodiments, the system may include a user interface configured to display a turning radius of the work vehicle. As such, the user interface may include a suitable graphical user interface (e.g., a screen, display, and/or the like) for displaying the turning radius to the operator of the work vehicle. Additionally, the user interface may be configured to receive an operator selection of the displayed turning radius as the desired turning radius of the work vehicle. For example, in one embodiment, the graphical user interface may display a single turning radius. In such an embodiment, the user interface may include a first interface element(s) (e.g., a button(s), a knob(s), and/or the like) configured to adjust the value of the displayed turning radius. Moreover, the user interface may include a second interface element (e.g., a button, a knob, and/or the like) configured to receive an operator selection of the currently displayed turning radius as the desired turning radius of the work vehicle. In another embodiment, the graphical user interface may display a plurality of different turning radii options. In such an embodiment, the graphical user interface may include a plurality of interface elements (e.g., touch screen buttons), with each interface element corresponding to one of the plurality of different turning radii. Furthermore, each interface element may be configured to receive the operator selection. In this regard, when one of the interface elements receives the operation selection, the corresponding turning radius is selected as the desired turning radius of the work vehicle.

In accordance with aspects of the present subject matter, the system may control the operation of the work vehicle such that the vehicle is moved along a travel path having the desired turning radius. Specifically, a controller of the disclosed system may be configured to receive an input associated with the desired turning radius of the work vehicle from the user interface. Furthermore, the controller may be configured to determine a first rotational speed for a first traction device (e.g., one of an inner or outer wheel or track) of the work vehicle based on the desired turning radius. Similarly, the controller may be configured to determine a second rotational speed for a second traction device (e.g., the other of the inner or outer wheel or track) of the work vehicle based on the desired turning radius. The first and second rotational speeds may, in turn, differ by a rotational speed differential associated with the desired turning radius. Thereafter, the controller may be configured to control the operation of first and second motors of the work vehicle to rotationally drive the first and second traction devices at the first and second rotational speeds, respectively, such that the work vehicle is moved along the travel path having the desired turning radius. Additionally, in one embodiment, the work vehicle is moved along the travel path having the desired turning radius until an operator control device (e.g., a joystick, steering wheel, and/or the like) of the work vehicle receives a manual steering input, thereby overriding the desired turning radius.

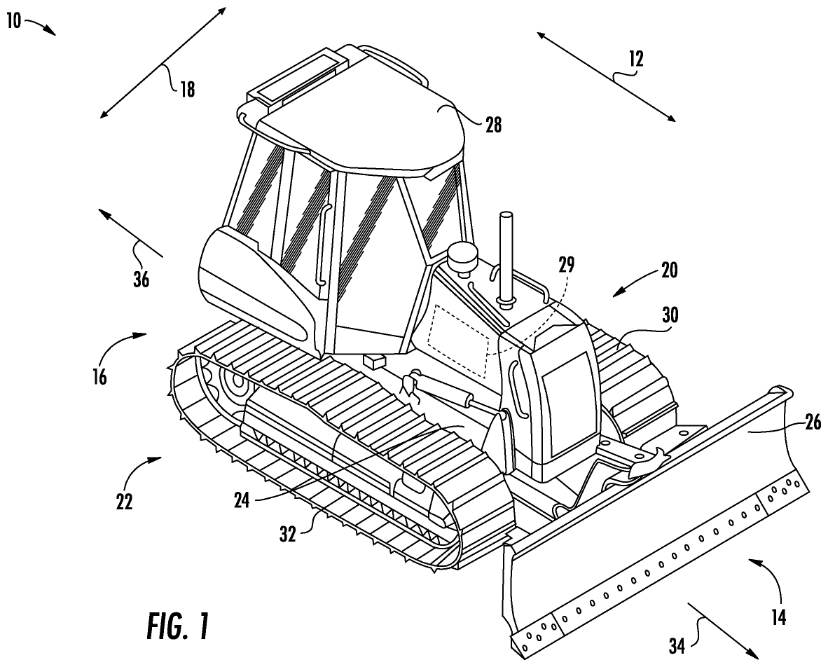

Referring now to the drawings, FIG. 1 illustrates a perspective view of one embodiment of a work vehicle 10. In general, the work vehicle 10 may extend longitudinally (e.g., as indicated by arrow 12 in FIG. 1) between a forward end 14 of the work vehicle 10 and an aft end 16 of the work vehicle 10. In addition, the work vehicle 10 may also extend laterally (e.g., as indicated by arrow 18 in FIG. 1) between a first side 20 of the work vehicle 10 and a second side 22 of the work vehicle 10. As shown, in the illustrated embodiment, the work vehicle 10 is configured as a construction vehicle (e.g., a crawler dozer). However, in alternative embodiments, the work vehicle 10 may be configured as any other suitable work vehicle known in the art, including those for agricultural and construction applications, transport, sport, and/or the like.

As shown in FIG. 1, the work vehicle 10 may include a chassis 24 configured to support or couple to a plurality of components. Specifically, in several embodiments, the chassis 24 may be configured to support a work implement 26 at the forward end 14 of the work vehicle 10. For example, as shown, in one embodiment, the work implement 26 may be configured as a grading implement (e.g., a blade) configured to remove a layer of soil from the surface across which the work vehicle 10 is traveling. Furthermore, the chassis 24 may be configured to support an operator's cab 28 at the aft end 16 of the work vehicle 10. The cab 28 may, in turn, include an operator control device(s), a user interface(s), and/or other controls that permit an operator to control the operation of the work vehicle 10. Moreover, an engine 29 for powering the work vehicle 10 may be mounted on the chassis 24. However, in alternative embodiments, the chassis 24 may be configured to support or couple to any suitable work vehicle. For example, in one alternative embodiment, the work implement 26 may be configured as a bucket configured to transport a quantity of soil, debris, or other materials.

Additionally, in several embodiment, the work vehicle 10 may include a plurality of traction devices coupled to the chassis 24. As shown, in one embodiment, a first track 30 may be coupled to the chassis 24 on the first side 20 of the work vehicle 10. Similarly, a second track 32 may be coupled to the chassis 24 on the second side 22 of the work vehicle 10 opposite the first track 30. As such, the tracks 30, 32 may be configured to move the work vehicle 10 in a forward direction (e.g., as indicated by arrow 34 in FIG. 1) and/or a reverse direction (e.g., as indicated by arrow 36 in FIG. 1). However, in alternative embodiments, the work vehicle 10 may include any other suitable traction devices in addition to or in lieu of the tracks 30, 32. For example, in one alternative embodiment, the work vehicle 10 may include a plurality of wheels (not shown) coupled the chassis 24.

It should be appreciated that, when the work vehicle 10 is turned, one of the tracks 30, 32 may correspond to an inner track (i.e., relative to the direction of the turn) and the other the tracks 30, 32 may correspond to the outer track (i.e., relative to the direction of the turn). For example, when the work vehicle 10 is turned to the left, the first track 30 (i.e., the track on the left side of the vehicle 10) corresponds to the inner track and the second track 32 (i.e., the track on the right side of the vehicle 10) corresponds to the outer track. However, when the work vehicle 10 is turned to the right, the second track 32 (i.e., the track on the right side of the vehicle 10) corresponds to the inner track and the first track 30 (i.e., the track on the left side of the vehicle 10) corresponds to the outer track.

Additionally, it should be appreciated that, when the work vehicle 10 is being turned, the outer track may generally rotate faster than the inner track. More specifically, the outer track must travel a greater distance than the inner track over the duration of the turn. As such, a rotational speed differential may exist between the inner and outer tracks when the work vehicle 10 is being turned. In general, the magnitude of the rotational speed differential may be determined by or may otherwise be indicative of the turning radius of the work vehicle 10. For example, the turning radius of the work vehicle may be smaller (i.e., the turn is “sharper”) when the rotational speed differential is greater. Conversely, the turning radius of the work vehicle may be greater (i.e., the turn is “wider”) when the rotational speed differential is smaller.

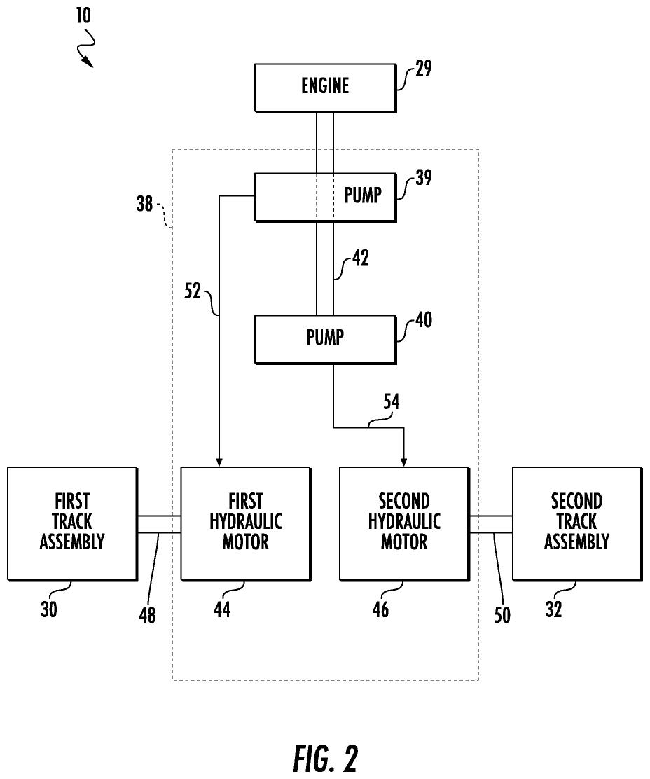

Referring now to FIG. 2, a schematic view of various components of the work vehicle 10 is illustrated in accordance with aspects of the present subject matter. For example, in several embodiments, the work vehicle 10 may include a hydrostatic transmission 38. Specifically, the hydrostatic transmission 38 may include first and second pumps 39, 40 configured to be rotationally driven by the engine 29, such as via a drive shaft 42. The hydrostatic transmission 38 may also include first and second hydraulic motors 44, 46. As such, a first hydraulic motor 44 may be configured to rotationally drive the first track 30 (e.g., via a first axle segment 48), while a second hydraulic motor 46 may be configured to rotationally drive the second track 32 (e.g., via a second axle segment 50). Moreover, the hydrostatic transmission 38 may include a first fluid conduit 52 configured to fluidly couple the first pump 39 to the first hydraulic motor 44 and a second fluid conduit 54 configured to fluidly couple the second pump 40 to the second hydraulic motor 46. However, in alternative embodiments, the hydrostatic transmission 38 may have any other suitable configuration. For example, in one embodiment, the hydrostatic transmission 38 may include a single pump that is rotationally driven by the engine 29, with such pump configured to be fluidly coupled to the first and second hydraulic motors 44, 46 via the first and second fluid conduits 52, 54.

In general, the hydrostatic transmission 38 may be configured to transmit power generated by the engine 29 to the tracks 30, 32. More specifically, the engine 29 may be configured to combust or otherwise burn a mixture of air and fuel to rotationally drive the drive shaft 42. The driveshaft 42 may, in turn, rotationally drive the first and second pumps 39, 40 in a manner that generates a pressurized flow of a fluid (e.g., hydraulic oil) within the first and second conduits 52, 54, respectively. In this regard, the first fluid conduit 52 may deliver a pressurized fluid flow generated by the first pump 39 to the first hydraulic motor 44, thereby rotationally driving the first hydraulic motor 44 and the associated first track 30. Similarly, the second fluid conduit 54 may deliver a pressurized fluid flow generated by the second pump 40 to the second hydraulic motor 46, thereby rotationally driving the second hydraulic motor 46 and the associated second track 32. As will be described below, the flow to each hydraulic motor 44, 46 may be adjusted (e.g., by controlling the operation of pumps 39, 40 and/or valves provided in association with the conduits 52, 54) when the work vehicle 10 is being turned to create the rotational speed differential between the first and second tracks 30, 32 associated with the desired turning radius of the work vehicle 10. However, in alternative embodiments, the first and second tracks 30, 32 may be rotationally driven in any outer suitable manner. For example, in one alternative embodiment, the first and second tracks 30, 32 may be rotationally driven by first and second electric motors (not shown), respectively.

It should be further appreciated that the configuration of the work vehicle 10 described above and shown in FIGS. 1 and 2 is provided only to place the present subject matter in an exemplary field of use. Thus, it should be appreciated that the present subject matter may be readily adaptable to any manner of vehicle configuration.

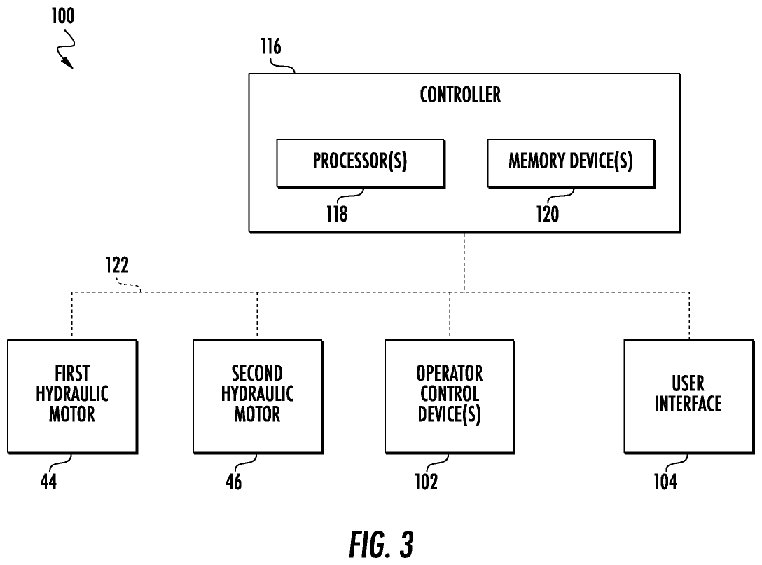

Referring now to FIG. 3, a schematic view of one embodiment of a system 100 for controlling the operation of a work vehicle is illustrated in accordance with aspects of the present subject matter. In general, the system 100 will be described herein with reference to the work vehicle 10 described above with reference to FIGS. 1 and 2. However, it should be appreciated by those of ordinary skill in the art that the disclosed system 100 may generally be utilized with work vehicles having any other suitable vehicle configuration.

As shown in FIG. 3, the system 100 may include one or more operator control devices 102 of the work vehicle 10. In general, the operator control device(s) 102 may be located within the cab 28 (FIG. 1) of the work vehicle 10 and configured to receive an operator input(s) associated with controlling one or more operating parameters of the work vehicle 10. Specifically, in several embodiments, the operator control device(s) may be configured to receive operator inputs associated with the ground speed and the direction of travel of the work vehicle 10. For example, in one embodiment, a first operator control device may be configured to receive operator inputs associated with the desired ground speed of the vehicle from the operator. Moreover, the first operator control device may also be configured to receive operator inputs associated with a selection of either the forward direction 34 (FIG. 1) or the reverse direction 36 (FIG. 1) from the operator. Furthermore, in such an embodiment, a second operator control device may be configured to receive manual steering inputs for the work vehicle 10 from the operator. However, in alternative embodiments, the system 100 may include any other suitable number of operator control devices 102, such as one operator control device 102 or three or more operator control devices 102. Additionally, the operator control device(s) 102 may be configured to receive operator inputs associated with controlling any other suitable operating parameter(s) of the work vehicle 10.

The operator control device(s) 102 may correspond to any suitable device(s) or structure(s) configured to receive operator inputs for controlling one or more operating parameters of the work vehicle 10. In general, the operator control device(s) 102 may be configured to convert the operator input(s) (e.g., the movement of the operator control device(s) 102) into a signal(s) (e.g., an electric or wireless signal(s)) or other suitable type of data that a controller can interpret. Thereafter, the operator control device(s) 102 may be configured to transmit the signal(s) to the controller for controlling the corresponding operating parameter(s) of the work vehicle 10. For example, in one embodiment, the first operator control device may be configured as a throttle lever and the second operator control device may be configured as a joystick. However, in alternative embodiments, the operator control device(s) 102 may be configured as any other suitable device(s) for receiving operator input(s) for controlling the operating parameter(s) of the work vehicle 10, such as a lever(s), a joystick(s), a steering wheel(s), a pedal(s), and/or the like.

Furthermore, as shown, the system 100 may also include a user interface 104. In general, the user interface 104 may be configured to display a turning radius of the work vehicle 10 and receive an operator selection of the displayed turning radius as a desired turning radius of the vehicle 10. In this regard, and as will be described below, the user interface 104 may include various interface elements that allow the operator of the work vehicle 10 to select the desired turning radius of the vehicle 10. After the operator has selected the desired turning radius, the user interface 104 may be configured to transmit data to the controller for controlling the operation of one or more components of the work vehicle 10 such that the vehicle 10 is moved along a travel path having the desired turning radius. Moreover, in several embodiments, the user interface 104 may be installed or otherwise positioned within the cab 28 (FIG. 1) of the work vehicle 10. However, in alternative embodiments, the user interface 104 may be positioned at a remote location, such as in a farm management office or on a mobile device (e.g., a Smartphone or tablet).

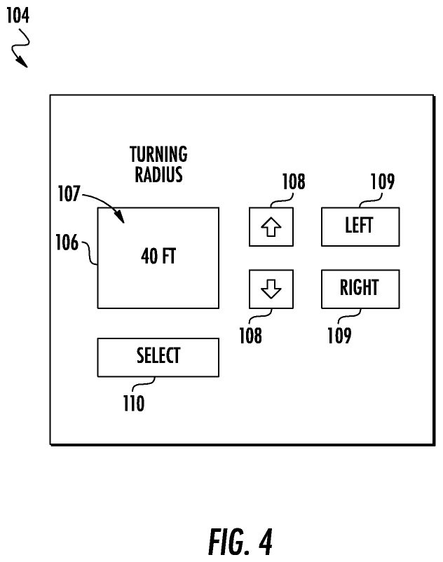

Referring now to FIG. 4, an example view of one embodiment of a suitable user interface 104 for displaying a turning radius of a work vehicle and receiving an operator selection of the displayed turning radius as the desired turning radius of the vehicle in accordance with aspects of the present subject matter. In several embodiments, the user interface 104 may be configured to display a single turning radius value for the work vehicle 10 that the operator may adjust until the desired turning radius value is displayed. Specifically, in one embodiment, the user interface may include a suitable a screen or display 106 (e.g., an LCD screen) that displays a graphical user interface 107 providing a numerical indication of the single turning radius value for work vehicle 10 (which in the illustrated embodiment is forty feet). In such an embodiment, the user interface 104 may also include one or more first interface elements 108 configured to receive operator inputs associated with adjusting the turning radius value displayed by the graphical user interface 107. For example, in the illustrated embodiment, the user interface 104 includes a pair of first interface elements 108. In such an embodiment, one of the first interface elements may be configured to increase the displayed turning radius value (e.g., the first interface element 108 having the “up” arrow), while the other of the first interface elements may be configured to decrease the displayed turning radius value (e.g., the first interface element 108 having the “down” arrow). Furthermore, in the illustrated embodiment, the first interface elements 108 are configured as buttons on the user interface 104 that are separate from the display/graphical user interface 106/107. However, in alternative embodiments, the first interface element(s) 108 may be object(s) displayed on the graphical user interface 107 (e.g., touch-screen buttons) or any other suitable interface element(s), such as a knob(s), a dial(s), a switch(es), and/or the like. Moreover, in one embodiment, the user interface 104 may include a plurality of second interface elements 109 configured to receive an operator selection of a direction (e.g., left or right) of the desired turning radius. In such an embodiment, one of the second interface elements 109 may be configured to select a left turn (e.g., the second interface element 109 displaying “LEFT”), while the other of the second interface elements 109 may be configured to select a right turn (e.g., the second interface element 109 displaying “RIGHT”). Additionally, the user interface 104 may include a third interface element 110 configured to receive an operator selection of the desired turning radius of the work vehicle 10.

In this regard, the operator of the work vehicle 10 may interact with or otherwise utilize the user interface 104 to provide a desired turning radius to a controller of the system 100. More specifically, as shown, the graphical user interface 107 may display a turning radius value (e.g., forty feet in the embodiment illustrated in FIG. 4) for the work vehicle 10. The operator may interact with the first interface elements 108 to increase and/or decrease the turning radius value being displayed by the graphical user interface 107 on the display 106. For example, when the operator interacts with (e.g., presses) the first interface element 108 having the “up” arrow, the displayed turning radius value may be increased by a predetermined increment (e.g., five feet). As such, if the operator would like to increase the turning radius value from forty feet to fifty feet, he/she may interact with (e.g., press) the first interface element 108 having the “up” arrow two times. Conversely, when the operator interacts with (e.g., presses) the first interface element 108 having the “down” arrow, the displayed turning radius value may be decreased by a predetermined increment (e.g., five feet). As such, the operator may interact with (e.g., press) the first interface elements 108 until the desired turning radius for the work vehicle 10 is displayed by the graphical user interface 107 on the display 106. The operator may then interact with (e.g., press) one of the second interface elements 109 to select a direction (e.g., right or left) for the desired turning radius. Moreover, the operator may interact with (e.g., press) the third interface element 110 select the displayed turning radius value as the desired turning radius for the work vehicle 10. Thereafter, as will be described below, a controller may be configured to control the operation of the various components of the work vehicle 10 (e.g., the first and second hydraulic motors 44, 46) such that the vehicle 10 is moved along a travel path having the desired turning radius and direction.

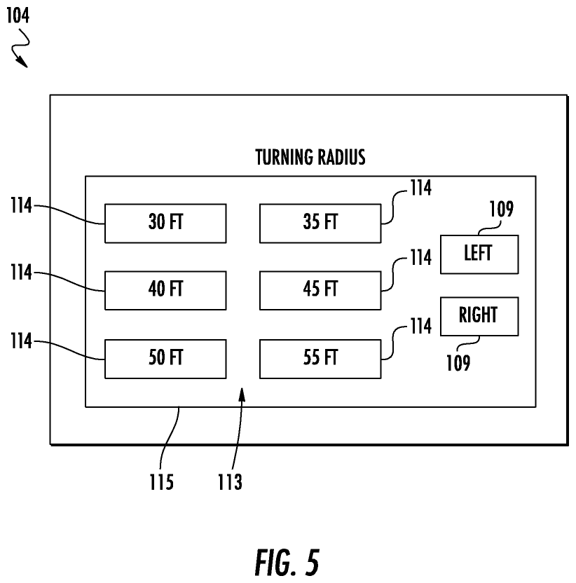

Referring now to FIG. 5, another example view of one embodiment of a suitable user interface 104 for displaying a turning radius of a work vehicle and receiving an operator selection of the displayed turning radius as the desired turning radius of the vehicle in accordance with aspects of the present subject matter. As shown, the user interface 104 may be configured to display a plurality of different turning radii for the work vehicle 10 for selection by the operator. Specifically, in such embodiments, the user interface 104 may include a screen or display 112 that displays a suitable graphical user interface 113 providing the various turning radii options to the operator. In this regard, the display/graphical user interface 112/113 may be configured to display a plurality of first interface elements or objects 114, with each first interface element 114 corresponding to one of the plurality of turning radii. As such, the operator may interact one of the first interface elements 114 to select the turning radius being displayed in association with the such element 114 as the desired turning radius for the work vehicle 10. For example, in the illustrated embodiment, the graphical user interface 113 includes six interface first elements 114 (e.g., touch screen buttons), with each first interface element 114 having a different turning radius displayed in association therewith. In this regard, when the operator would like the work vehicle 10 to be moved along a travel path having a turning radius of fifty feet, he/she may interact with (e.g., press) the first interface element 114 corresponding to a turning radius of fifty feet, thereby selecting fifty feet as the desired turning radius. Additionally, in one embodiment, the display/graphical user interface 112/113 may include a plurality of second interface elements 109 configured to receive an operator selection of a direction (e.g., left or right) of the desired turning radius. In such an embodiment, one of the second interface elements 109 may be configured to select a left turn (e.g., the second interface element 109 displaying “LEFT”), while the other of the second interface elements 109 may be configured to select a right turn (e.g., the second interface element 109 displaying “RIGHT”). However, in alternative embodiments, the graphical user interface 113 may include any other suitable number of interface elements 114 such that any other suitable number of turning radii for the work vehicle 10 are displayed to the operator. Moreover, the user interface 104 may have any other suitable configuration. For example, the plurality of turning radii may be displayed in association with physical buttons, knobs, switches, and/or the like.

Referring again to FIG. 3, the system 100 may include a controller 116 positioned on and/or within or otherwise associated with the work vehicle 10. In general, the controller 116 may comprise any suitable processor-based device known in the art, such as a computing device or any suitable combination of computing devices. Thus, in several embodiments, the controller 116 may include one or more processor(s) 118 and associated memory device(s) 120 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 120 of the controller 116 may generally comprise memory element(s) including, but not limited to, a computer readable medium (e.g., random access memory (RAM)), a computer readable non-volatile medium (e.g., a flash memory), a floppy disc, a compact disc-read only memory (CD-ROM), a magneto-optical disc (MOD), a digital versatile disc (DVD), and/or other suitable memory elements. Such memory device(s) 120 may generally be configured to store suitable computer-readable instructions that, when implemented by the processor(s) 118 configure the controller 116 to perform various computer-implemented functions.

In addition, the controller 116 may also include various other suitable components, such as a communications circuit or module, a network interface, one or more input/output channels, a data/control bus and/or the like, to allow controller 116 to be communicatively coupled to any of the various other system components described herein (e.g., the first hydraulic motor 44, the second hydraulic motor 46, the operator control device(s) 102, and/or the user interface 104). For instance, as shown in FIG. 3, a communicative link or interface 122 (e.g., a data bus) may be provided between the controller 116 and the components 44, 46, 102, 104 to allow the controller 116 to communicate with such components 44, 46, 102, 104 via any suitable communications protocol (e.g., CANBUS).

It should be appreciated that the controller 116 may correspond to an existing controller(s) of the work vehicle 10 itself, or the controller 116 may correspond to a separate processing device. For instance, in one embodiment, the controller 116 may form all or part of a separate plug-in module that may be installed in association with the work vehicle 10 to allow for the disclosed systems to be implemented without requiring additional software to be uploaded onto existing control devices of the vehicle 10. It should also be appreciated that the functions of the controller 116 may be performed by a single processor-based device or may be distributed across any number of processor-based devices, in which instance such devices may be considered to form part of the controller 116. For instance, the functions of the controller 108 may be distributed across multiple application-specific controllers, such as a navigation controller, an engine controller, a transmission controller, and/or the like.

In several embodiments, the controller 116 may be configured to provide for display on the user interface 104 one or more turning radii of the work vehicle 10. Specifically, as described above, in one embodiment, the user interface 104 may be configured to display a single adjustable turning radius value (e.g., on the graphical user interface 107 on the display 106) to the operator of the work vehicle 10. In such an embodiment, the controller 116 may be configured to transmit instructions to the user interface 104 (e.g., the communicative link 122) instructing the user interface 104 to display such a single, adjustable turning radius value (e.g., via the graphical user interface 107 on the display 106). Furthermore, as described above, in another embodiment, the user interface 104 may be configured to display a plurality of turning radii for the work vehicle 10. In such an embodiment, the user interface 104 may include a plurality of interface elements (e.g., via the first interface elements 114 of the graphical user interface 113), with each interface element corresponding to one of the plurality of turning radii. As such, the controller 116 may be configured to transmit instructions to the user interface 104 (e.g., the communicative link 122) instructing the user interface 104 to display the plurality of turning radii for the work vehicle to the operator.

Furthermore, in several embodiments, the controller 116 may be configured to receive an input associated with an operator selection of one of the displayed turning radii as the desired turning radius for the work vehicle 10. Specifically, in embodiments in which a single, adjustable turning radius value is displayed, the operator may adjust the displayed value (e.g., via the first interface element(s) 108) until the user interface 104 displays the desired turning radius of the vehicle 10. The operator may also provide an operator selection (e.g., via the second interface elements 109) of a selected direction (e.g., right or left) for the desired turning radius. Thereafter, the operator may provide the operator selection (e.g., via the third interface element 110) to the user interface 104, thereby selecting the turning radius currently displayed by the user interface 104 as the desired turning radius of the work vehicle 10. Alternatively, in embodiments in which a plurality of turning radii are displayed, the operator may provide the operator selection (e.g., via one of the first interface elements 114) to the user interface 104, thereby selecting one of the plurality of displayed turning radii as the desired turning radius of the work vehicle 10. Furthermore, the operator may also provide an operator selection (e.g., via the second interface elements 109) of a selected direction (e.g., right or left) for the desired turning radius. Upon receipt of the operator selection of the desired turning radius of the work vehicle 10, the user interface 104 may transmit data indicative of such operator selections to the controller 116 (e.g., via the communicative link 122).

Furthermore, the controller 116 may be configured to determine rotational speeds for a plurality of traction devices of the work vehicle 10 based on the desired turning radius and selected direction for the turn. As described above, when the work vehicle 10 is being turned, the outer traction device may generally rotate at a greater rotational speed than the inner traction device such that a rotational speed differential exists between the inner and outer traction devices. Moreover, the magnitude of such rotational speed differential may generally be indicative of the turning radius of the work vehicle 10. As such, the controller 116 may be configured to determine a first rotational speed for a first traction device (e.g., the first track 30) of the work vehicle 10 based on the desired turning radius. Moreover, the controller 116 may be configured to determine a second rotational speed for the second traction device (e.g., the second track 32) based on the desired turning radius, with second rotational speed differing from the first rotational speed by a rotational speed differential associated with the desired turning radius. For instance, the controller 116 may include a look-up table(s), suitable mathematical formula, and/or algorithms stored within its memory 120 that correlates the desired turning radius to the first and second rotational speeds of the first and second traction devices, respectively.

Additionally, the controller 116 may be configured to receive an operator selection of either a forward direction of travel or a reverse direction of travel for the work vehicle 10. As described above, the work vehicle 10 may be moved in either the forward direction 34 (FIG. 1) or the reverse direction (FIG. 2). As such, an operator control device 102 of the work vehicle 10 may be configured to receive an operator input associated with a selection of either the forward direction 34 (FIG. 1) or the reverse direction (FIG. 2). Upon receipt of such operator selection, the operator control device 102 may transmit data indicative of the selected direction to the controller 116 (e.g., via the communicative link 122).

In accordance with aspects of the present subject matter, the controller 116 may be configured to control the operation of the work vehicle 10 such that the vehicle 10 is moved along a travel path having the desired turning radius and turning direction. Specifically, in several embodiments, upon receipt of the selected direction, the controller 116 may be configured to control the operation of first and second motors of the work vehicle 10 such that the first and second traction devices are rotationally driven at the determined first and second rotational speeds, respectively. When the first and second traction devices rotate at first and second rotational speeds, respectively, the work vehicle 10 may be moved along a travel path having the desired turning radius in the selected direction such that the vehicle 10 is able to execute a turn having a generally constant radius.

In several embodiments, the controller 116 may be configured to control the operation of the hydrostatic transmission 38 of the work vehicle 10 such that the vehicle 10 is moved along a travel path having the desired turning radius. Specifically, as described above, the hydrostatic transmission 38 may include first and second hydraulic motors 44, 46 configured to rotationally drive the first and second tracks 30, 32 of the work vehicle 10, respectively. Furthermore, the hydrostatic transmission 38 may include a first pump 39 configured to supply a pressurized fluid flow to the first hydraulic motor 44 and a second pump 40 configured to supply a pressurized fluid flow to the second hydraulic motor 46. As such, upon receipt of the selected direction from the operator control device 102, the controller 116 may be configured to transmit instructions to controllers (not shown) of the first and second pumps 39, 40 (e.g., via the communicative link 122). Such instructions may, in turn, instruct the first pump 39 to generate a pressurized fluid flow such that the first hydraulic motor 44 rotationally drives the first track 30 at the determined first rotational speed. Furthermore, the instructions may instruct the second pump 40 to generate a pressurized fluid flow such that the second hydraulic motor 46 rotationally drives the second track 32 at the determined second rotational speed. However, in alternative embodiments, the hydrostatic transmission 38 may be controlled in any other suitable manner to rotationally drive the first and second tracks 30, 32 at the determined first and second rotational speeds, respectively. For example, in embodiments in which the hydrostatic transmission 38 includes a single pump, the controller 116 may be configured to transmit the instructions to one or more valves (not shown) provided in operative association with the first and second fluid conduits 52, 54. Such instructions may, in turn, instruct the valve(s) to divide the flow generated by the pump between the first and second hydraulic motors 44, 46 in a manner that rotationally drives the first and second tracks 30, 32 at the determined first and second rotational speeds, respectively.

Moreover, as the work vehicle 10 is moved along the travel path, the controller 116 may be configured to adjust the first and second rotational speeds of the first and second traction devices of based on the desired ground speed of the vehicle. As described above, an operator control device 102 of the work vehicle 10 may be configured to receive an operator input associated with a desired ground speed of the vehicle 10. In this regard, as the work vehicle 10 is moved along the travel path, the operator may provide an operator input to the operator control device 102 indicative of the desired ground speed of the vehicle 10. The operator control device 102 may, in turn, be configured to transmit data indicative of such desired ground speed to the controller 116 (e.g., via the communicative link 122). When the desired ground speed differs from the current ground speed, the controller 116 may be configured to update or adjust the first and second rotational speeds determined for the first and second traction devices. Specifically, the first and second rotational speeds are adjusted such that the work vehicle 10 is moved along the travel path at the desired ground speed, while still maintaining the desired turning radius. As such, the adjusted first and second rotational speeds may differ by the rotational speed differential associated with the desired turning radius. Thereafter, the controller 116 may control the operation of the first and second motors (e.g., the first and second hydraulic motors 44, 46) such that first and second traction devices (e.g., the first and second tracks 30, 32) are rotationally driven at the first and second adjusted rotational speeds, respectively. In this regard, the operator is able to adjust the ground speed of the work vehicle 10 as the vehicle 10 is moved along the travel path without affecting the desired turning radius.

Furthermore, as the work vehicle 10 is moved along the travel path, the controller 116 may be configured to override the desired turning radius of the vehicle upon receipt of a manual steering input. As described above, an operator control device 102 of the work vehicle 10 may be configured to receive a manual steering input from the operator. In this regard, as the work vehicle 10 is moved along the travel path, the operator may override the desired turning radius of the vehicle 10 by providing a manual steering input to the operator control device 102. The operator control device 102 may, in turn, be configured to transmit data indicative of such manual steering input to the controller 116 (e.g., via the communicative link 122). Upon receipt of the manual steering input data, the controller 116 may override the desired steering input provided to the user interface 104. In such instances, the controller 116 may control the operation of the first and second motors (e.g., the first and second hydraulic motors 44, 46) such that the first and second traction devices (e.g., the first and second tracks 30, 32) are rotationally driven at first and second rotational speeds associated with the manual steering input. As such, the operator may be able to cease movement of the work vehicle 10 along the travel path having the desired turning radius when an obstacle is present in the travel path or the vehicle 10 has completed the constant radius turn.

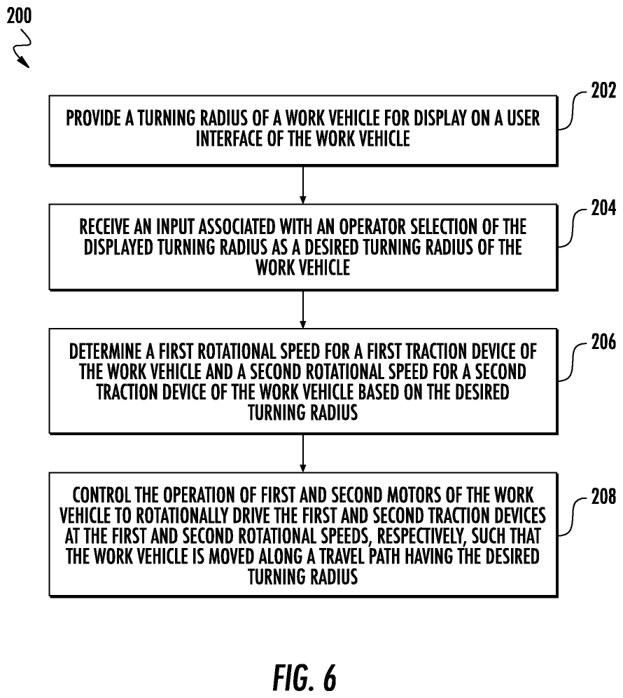

Referring now to FIG. 6, a flow diagram of one embodiment of a method 200 for controlling the operation of a work vehicle is illustrated in accordance with aspects of the present subject matter. In general, the method 200 will be described herein with reference to the work vehicle 10 and the system 100 described above with reference to FIGS. 1-5. However, it should be appreciated by those of ordinary skill in the art that the disclosed method 200 may generally be implemented with any work vehicle having any suitable vehicle configuration and/or any system having any suitable system configuration. In addition, although FIG. 6 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 6, at (202), the method 200 may include providing, with one or more computing devices, a turning radius of a work vehicle for display on a user interface of the work vehicle. For instance, as described above, the controller 116 may be configured to provide a turning radius of a work vehicle 10 for display on a user interface 104 of the vehicle 10.

Additionally, at (204), the method 200 may include receiving, with the one or more computing devices, an input associated with an operator selection of the displayed turning radius as a desired turning radius of the work vehicle. For instance, as described above, the controller 116 may be configured to receive an input associated with an operator selection of the turning radius currently displayed by the user interface 104 as a desired turning radius of the work vehicle 10.

Moreover, as shown in FIG. 6, at (206), the method 200 may include determining, with the one or more computing devices, a first rotational speed for a first traction device of the work vehicle and a second rotational speed for a second traction device of the work vehicle based on the desired turning radius. For instance, as described above, the controller 116 may be configured to determine a first rotational speed for a first track 30 of the work vehicle 10 and a second rotational speed for a second track 32 of the vehicle 10 based on the desired turning radius.

Furthermore, at (208), the method 200 may include controlling, with the one or more computing devices, the operation of the first and second motors to rotationally drive the first and second traction devices at the first and second rotational speeds, respectively, such that the work vehicle is moved along a travel path having the desired turning radius. For instance, as described above, the controller 116 may be configured to control the operation of first and second hydraulic motors 44, 46 to rotationally drive the first and second tracks 30, 32 at the first and second rotational speeds, respectively, such that the work vehicle 10 is moved along a travel path having the desired turning radius.

It is to be understood that the steps of the method 200 are performed by the controller 116 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the controller 116 described herein, such as the method 200, is implemented in software code or instructions which are tangibly stored on a tangible computer readable medium. The controller 116 loads the software code or instructions via a direct interface with the computer readable medium or via a wired and/or wireless network. Upon loading and executing such software code or instructions by the controller 116, the controller 116 may perform any of the functionality of the controller 116 described herein, including any steps of the method 200 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A system for controlling the operation of a work vehicle, the system comprising:
first and second traction devices, one of the first traction device or the second traction device corresponding to an inner traction device of the work vehicle and the other of the first traction device or the second traction device corresponding to an outer traction device of the work vehicle when the work vehicle is being turned;
a first motor configured to rotationally drive the first traction device;
a second motor configured to rotationally drive the second traction device;
a user interface configured to display a turning radius of the work vehicle; and
a controller communicatively coupled to the user interface, the controller configured to:
provide for display on the user interface the turning radius of the work vehicle;
receive an input associated with an operator selection of the displayed turning radius as a desired turning radius;
determine a first rotational speed for the first traction device and a second rotational speed for the second traction device based on the desired turning radius, the first rotational speed differing from the second rotational speed by a rotational speed differential associated with the desired turning radius; and
control the operation of the first and second motors to rotationally drive the first and second traction devices at the first and second rotational speeds, respectively, such that the work vehicle is moved along a travel path having the desired turning radius.

2. The system of claim 1, wherein the user interface comprises a graphical user interface for displaying the turning radius.

3. The system of claim 2, wherein the user interface further comprises a first interface element configured to receive an operator input associated with adjusting the turning radius displayed by the graphical user interface and a second interface element configured to receive the operator selection of the desired turning radius, the desired turning radius corresponding to the turning radius currently displayed by the graphical user interface when the operator selection received.

4. The system of claim 2, wherein the turning radius comprises a plurality of turning radii of the work vehicle, the graphical user interface comprising a plurality of interface elements, each interface element corresponding to one turning radius of the plurality of turning radii.

5. The system of claim 1, further comprising:
an operator control device configured to receive an operator input associated with a desired ground speed of the work vehicle, the operator input device communicatively coupled to the controller, wherein the controller is further configured to:
receive the operator input from the operator control device; and
adjust the first and second rotational speeds based on the desired ground speed.

6. The system of claim 1, further comprising:
an operator control device configured to receive an operator input associated with a selected direction of a forward direction or a reverse direction, the operator input device communicatively coupled to the controller, wherein the controller is further configured to:
receive the operator input from the operator control device; and
control the operation of the first and second motors to rotationally drive the first and second traction devices at the first and second rotational speeds, respectively, in the selected direction.

7. The system of claim 1, further comprising:
an operator control device configured to receive a manual steering input from the operator, the operator control device communicatively coupled to the controller, wherein the controller is further configured to:
receive the manual steering input from the operator control device when the work vehicle is moved along the travel path; and
upon receipt of the manual steering input, override the desired radius based on the manual steering input.

8. The system of claim 1, wherein the first motor and the second motor comprise a first hydraulic motor and a second hydraulic motor, respectively.

9. The system of claim 1, wherein the first and second traction devices comprise first and second tracks, respectively.

10. The system of claim 1, wherein the work vehicle comprises a construction vehicle.

11. A method for controlling the operation of a work vehicle, the work vehicle including first and second traction devices, a first motor configured to rotationally drive the first traction device, and a second motor configured to rotationally drive the second traction device, the method comprising:
providing, with one or more computing devices, a turning radius of the work vehicle for display on a user interface of the work vehicle, the user interface configured to display the turning radius of the work vehicle;
receiving, with the one or more computing devices, an input associated with an operator selection of the displayed turning radius as a desired turning radius;
determining, with the one or more computing devices, a first rotational speed for the first traction device and a second rotational speed for the second traction device based on the desired turning radius, the first rotational speed differing from the second rotational speed by a rotational speed differential associated with the desired turning radius; and
controlling, with the one or more computing devices, the operation of the first and second motors to rotationally drive the first and second traction devices at the first and second rotational speeds, respectively, such that the work vehicle is moved along a travel path having the desired turning radius.

12. The method of claim 11, wherein the user interface comprises a graphical user interface for displaying the turning radius.

13. The method of claim 12, wherein the user interface further comprises a first interface element configured to receive an operator input associated with adjusting the turning radius displayed by the graphical user interface and a second interface element configured to receive the operator selection of the desired turning radius, the desired turning radius corresponding to the turning radius currently displayed by the graphical user interface when the operator selection received.

14. The method of claim 12, wherein the turning radius comprises a plurality of turning radii of the work vehicle, the graphical user interface comprising a plurality of interface elements, each interface element corresponding to one turning radius of the plurality of turning radii.

15. The method of claim 11, further comprising:
receiving, with the one or more computing devices, an operator input from an operator control device of the work vehicle, the operator input associated with a desired ground speed of the work vehicle; and
adjusting, with one or more computing device, the first and second rotational speeds based on the desired ground speed.

16. The method of claim 15, further comprising:
receiving, with the one or more computing devices, an operator input from an operator control device of the work vehicle, the operator input associated with a selected direction of a forward direction or a reverse direction; and
controlling, with the one or more computing devices, the operation of the first and second motors to rotationally drive the first and second traction devices at the first and second rotational speeds, respectively, in the selected direction.

17. The method of claim 11, further comprising:
receiving, with the one or more computing devices, a manual steering input from an operator control device of the work vehicle when the work vehicle is moved along the travel path; and
upon receipt of the manual steering input, overriding, with the one or more computing devices, the desired radius based on the manual steering input.

18. The method of claim 11, wherein the first motor and the second motor comprise a first hydraulic motor and a second hydraulic motor, respectively.

19. The method of claim 11, wherein the first and second traction devices comprise first and second tracks, respectively.

20. The method of claim 11, wherein the work vehicle comprises a construction vehicle.
